(19) United States
(12) Patent Application Publication
(10) Pub. No.: US 2007/0109992 A1
(43) Pub. Date: May 17, 2007

(54) Indirect command pathways between an end point device and a target access point via a secondary access point

(75) Inventor: James D. Bennett, San Clemente, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/494,680

(22) Filed: Jul. 27, 2006

Related U.S. Application Data
(63) Continuation-in-part of application No. 11/365,102, filed on Mar. 1, 2006.
(63) Continuation-in-part of application No. 11/394,253, filed on Mar. 30, 2006.
(63) Continuation-in-part of application No. 11/418,644, filed on May 5, 2006.
(63) Continuation-in-part of application No. 11/448,240, filed on Jun. 6, 2006.
(60) Provisional application No. 60/736,889, filed on Nov. 14, 2005.

(51) Int. Cl. H04B 1/04; H04Q 7/00; H04Q 7/24

(52) U.S. Cl. 370/328; 455/127.4; 370/338

(57) ABSTRACT

An end point device that interacts with a first access point using a first radio and via a first direct pathway. The end point device interacts with at least a second access point using a second radio and via a second direct pathway. The end point device sends multimedia information packets and command packets meant for the first access point via the first direct pathway and using the second radio respectively. The first access point and the second access point are communicatively coupled via a plurality of communicatively incompatible packet switched data networks. The command packets reach the first access point traveling via the second direct pathway, the second access point and the plurality of packet switched data networks. The first access point responds to the command packets by causing a change in performance of the first radio and performance of the first direct pathway. The first access point sends a second command packet to the end point device via the second access point instead of sending via the first direct pathway. The second command packet triggers the end point device to respond by effectuating a change in interaction of the end point device with the first access point. The end point device follows two mutually incompatible protocols for communication along the first direct pathway and the second direct pathway.

The present application is a continuation-in-part of:

U.S. Utility application Ser. No. 11/365,102, filed Mar. 1, 2006 and entitled “MULTIPLE NODE APPLICATIONS COOPERATIVELY MANAGING A PLURALITY OF PACKET SWITCHED NETWORK PATHWAYS,” (attorney docket No. BP52754);

U.S. Utility application Ser. No. 11/394,253, filed Mar. 30, 2006 and entitled “NETWORK NODES COOPERATIVELY ROUTING TRAFFIC FLOW AMONGST WIRED AND WIRELESS NETWORK,” (attorney docket No. BP5276);

U.S. Utility application Ser. No. 11/418,644, filed May 5, 2006 and entitled “PATHWAY PARAMETER EXCHANGE BETWEEN ACCESS NETWORKS OF DIFFERING TYPES,” (attorney docket No. BP5319); and

U.S. Utility application Ser. No. 11/448,240, filed Jun. 6, 2006 and entitled “ACCESS POINT SUPPORTING DIRECT AND INDIRECT DOWNSTREAM DELIVERY BASED ON COMMUNICATION CHARACTERISTICS,” (attorney docket No. BP5329), all of which are incorporated by reference herein in their entirety for all purposes.

The present application claims priority to U.S. provisional application Ser. No. 60/736,889, filed Nov. 14, 2005, which is incorporated herein by reference for all purposes.

### FEDERALLY SPONSORED RESEARCH OR DEVELOPMENT

[Not Applicable]

### SEQUENCE LISTING

[Not Applicable]

### [MICROFICHE/COPYRIGHT REFERENCE]

[Not Applicable]

### BACKGROUND OF THE INVENTION

1. Field of the Invention

Various aspects of present invention relate to delivery of command data packet to a destination device via an indirect pathway instead of selecting a direct pathway to the destination device for delivery.

2. Description of the Related Art

A notebook, a personal computer, a video game box, a personal digital assistant, a headset, a phone, a set top box, servers and many other types of end point devices (EPDs) may be communicatively connected to more than one packet switched data networks. These packet switched data networks may operate pursuant to communicatively incompatible protocols. Typical examples of the packet switched data network include EDGE (Enhanced Data Rates for GSM Evolution) networks, GSM (Global System for Mobile Communications) networks, CDMA (Code Division Multiple Access) networks, IEEE (Institute of Electrical and Electronics Engineers) 802.11 networks, Bluetooth, WiMax networks, Internet, Intranet, satellite networks, etc.

Each EPD is typically assigned a unique network address by a packet switched data network. From a simplified point of view, an access point belonging to a packet switched data network acts as a transceiver with one end communicatively connected to an EPD and another to a node (e.g., router, modem, gateway, or switch) of the packet switched data network. EPDs exchange data packets via the access point. Some EPDs may associate with, multiple access points that belong to the same or different packet switched data networks. Such EPDs may have multiple radios, one for each association. Different packet switched data networks may be interconnected via a backbone network.

A typical EPD having no pending upstream communication either keeps its radio active (e.g., to receive unexpected downstream communication) or places it in a sleep mode. When active but not in use, portable EPDs consume battery power. EPDs that place their radios in sleep modes, i.e., turning off their radios; typically have a burden of periodically waking up, resynchronizing or reassociating, and checking for often non-existent pending communications. To sleep for longer periods of time increases average delivery time delay.

Further limitations and disadvantages of conventional and traditional approaches will become apparent to one of ordinary skill in the art through comparison of such systems with various aspects of the present invention.

### BRIEF SUMMARY OF THE INVENTION

An end point device that supports packet data communication with at least a first access point and a second access point and chooses an indirect pathway via the second access point for sending special purpose data packets to the first access point, substantially as shown in and/or described in connection with at least one of the figures, as set forth more completely in the claims. In addition the first access point and the second access point separately decide to send command data packets to the end point device indirectly via the second access point and the first access point respectively. These and other advantages, aspects and novel features of the present invention, as well details of illustrative aspects thereof, will be more fully understood from the following description and drawings.

### BRIEF DESCRIPTION OF THE DRAWINGS

For various aspects of the present invention to be easily understood and readily practiced, various aspects will now be described, for purposes of illustration and not limitation, in conjunction with the following figures:

FIG. 1 is a schematic block diagram of a communication network wherein end point devices employ indirect command pathways to a selected access point that supports a direct data pathway flowing through the selected access point in accordance with the present invention;

FIG. 2 is a schematic block diagram illustrating an end point device of FIG. 1, the end point device selecting and subsequently using an indirect command pathway for delivery of a command to an associated access point;

FIG. 3 is a schematic block diagram illustrating a first access point of FIG. 1 initiating delivery of a command to an end point device via a second access point to which the end point device is communicatively coupled instead of using a direct downstream pathway for the delivery of the command to the end point device;

FIG. 4 is a schematic block diagram illustrating a plurality of commands the end point device of FIG. 2 delivers to the associated access point using the indirect command pathway;

FIG. 5 is a schematic block diagram illustrating a plurality of commands the first access point of FIG. 3 delivers to the end point device using a pathway via the second access point;

FIG. 6 is a schematic block diagram illustrating a plurality of components of an end point device that supports a direct data pathway to a first access point and an indirect command pathway to the first access point via a second access point, where the end point device uses the indirect command pathway for delivery of a plurality of commands to the first access point;

FIG. 7 is a schematic block diagram illustrating a plurality of components of an access point 700 that supports a direct downstream pathway and additionally an indirect upstream pathway to an end point device, where the access point uses the indirect upstream pathway for delivery of a command to the end point device;

FIG. 8 is a flow chart illustrating a method of selecting a pathway for delivery of data packet to an access point and subsequent delivery via the selected pathway, where the selection of the pathway by an end point device is based on the data packet type; and

FIG. 9 is a flow chart illustrating a method of selecting a pathway for delivery of data packet to an end point device and subsequent delivery via the selected pathway, where the selection of the pathway by an access point is based on the data packet type.

### DETAILED DESCRIPTION

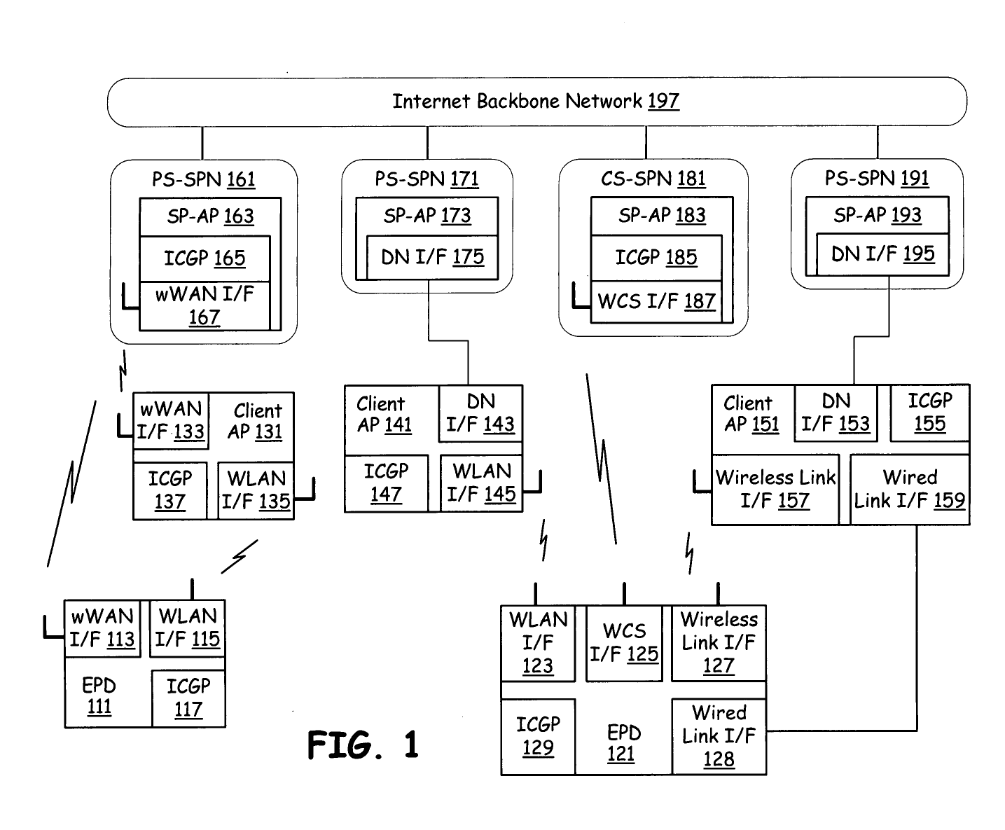

FIG. 1 is a schematic block diagram of a communication network wherein end point devices employ indirect command pathways to a selected access point that supports a direct data pathway flowing through the selected access point in accordance with the present invention. Two end point devices (EPDs) 111 and 121 exchange data via a direct data pathway that flows from one of the EPDs 111 and 121 through a selected AP (Access Point), through an Internet backbone network 197, and back through another AP to the other of the EPDs 111 and 121. EPDs 111 and 121 may comprise personal computing devices, telephones, personal digital assistants, servers, set top boxes, media players, storage systems, or any other source or destination Internet ready devices such as client or server equipment.

Each of the EPDs 111 and 121 establish an association with one of the available APs, herein a “selected AP”, through which the direct data pathway flows. To support the direct data pathway, each of the EPDs 111 and 121 and its selected AP establish an indirect command pathway via a secondary AP. Through the indirect command pathway, the EPD and selected AP can exchange commands (or service requests) outside of the direct data pathway. Such indirect command pathways can be used for many purposes such as, for example, to support or manage: a) security; b) data flow; c) handover; d) association, re-association and disassociation; e) persistent network connectivity; f) power conservation; g) load balancing; h) testing; and i) supplemental information exchange.

Along with conventional circuitry and software, the EPDs 111 and 121 have a series of communication interfaces and employ circuitry and/or software to carry out ICGP (“Indirect Command Generation and Processing”). Although all could be so configured, many of the illustrated APs also employ circuitry and/or software to carry out ICGP. As with the EPDs, the APs also have a series of communication interfaces for communicating upstream toward an Internet backbone network 197 and downstream toward an EPD. Each of the communication interfaces operate according to at least one industry or proprietary standard to conduct wired (herein, including fiber) and wireless communication exchanges.

To establish a direct data pathway, the EPD 111 uses its wWAN (wireless Wide Area Network) communication interface 113 to wirelessly communicate to wWAN downstream interface (I/F) 167 of an SP-AP (Service Provider's Access Point) 163. Any proprietary or industry standard wWAN might be used such as, for example, WiMax. Through this wWAN link, the EPD 111 associates with the service provider AP 163 to gain access through both the service provider AP 163 and packet switched service provider network (PS-SPN) 161 to reach the Internet backbone network 197. Similarly, the EPD 121 uses its wireless circuit switched communication interface (“WCS I/F”) 125 to wirelessly communicate to wireless circuit switched interface 187 of an SP-AP 183. The SP-AP 183 belongs to circuit switched service provider network CS-SPN 181. The EPD 121 reaches the Internet backbone network 197 via the SP-AP 183 that is part of the CS-SPN 181. The CS-SPN 181 may be a GPRS network. Each of the SP-AP 163 and the SP-AP 183 has at least one upstream communication interface (not shown). The SP-AP 163 and the SP-AP 183 interact with the Internet backbone network 197 via respective upstream communication interfaces.

To send data to the EPD 121, the EPD 111 transmits the data via its wWAN communication interface 113. The data travels upstream via the SP-AP 163 and the PS-SPN 161 to the Internet backbone network 197. The data then travels downstream from the Internet backbone network 197 to the EPD 121 via the CS-SPN 181 and the SP-AP 183. The EPD 121 receives the data from the SP-AP 183 via the WCS interface 125 of the EPD 121. A direct data pathway between the EPD 111 and the EPD 121 that flows through the SP-AP 163 thus comprises the wWAN communication interface 113 of the EPD 111, the wWAN downstream interface 167 of the SP-AP 163, the SP-AP 163 that belongs to PS-SPN 161, the Internet backbone network 197, the SP-AP 183 that belongs to the CS-SPN 181, the WCS interface 187 of the SP-AP 183 and the WCS interface 125 of the EPD 121. The data, during its upstream movement through the direct data pathway follows a formatting structure prescribed by the WiMax standard while during its downstream movement follows a formatting structure prescribed by the GPRS standard.

The EPD 111 associates itself with a client AP 131 via its WLAN interface 115. The WLAN interface 115 may typically support IEEE 802.11 protocol. The client AP 131 is a transceiver that has at least one downstream communication interface and at least one upstream communication interface. The client AP 131 has a WLAN downstream communication interface 135 and a wWAN upstream interface 133. The client AP 131 exchanges data with the EPD 111 via the WLAN downstream interface 135 using for example, the IEEE 802.11 protocol while exchanges data with the SP-AP 163 via the wWAN upstream interface 133 using for example, the WiMax protocol. The EPD 111 similarly supports a WLAN protocol for communication via the WLAN interface 115 and a wWAN protocol for communication via its wWAN interface 113. The EPD 111 has two communication interfaces, namely the wWAN interface 113 and the WLAN interface 115. Hence the EPD 111 is able to interact with two access points simultaneously.

The EPD 121 is adapted to use its four communication interfaces, namely WLAN interface 123, the WCS interface 125, wireless link interface 127 and wired link interface 128 to communicatively connect to a maximum of four access points simultaneously. In this exemplary case, the EPD 121 connects to client AP 141 via the WLAN interface 123, to the SP-AP 183 via the WCS interface 125, to client AP 151 via the wireless link interface 127 and again to the client AP 151 via the wired link interface 128. The EPD 121 is adapted to support four different communication protocols. As an example, the EPD 121 may be supporting IEEE 802.11 for data communication via the WLAN interface 123, GPRS for data communication via the WCS interface 125, Bluetooth for data communication via the wireless link interface 127 and SS7 for data communication via the wired link interface 127.

The client AP 141 has a downstream WLAN interface 145 via which the client AP 141 interacts with one EPD, the EPD 121 in this exemplary case. The client AP 141 in addition has an upstream data network (DN) interface 143 via which the client AP 141 interacts with SP-AP 173. The SP-AP 173 belongs to a packet switched service provider network 171 that may typically be a PSTN network. The PS-SPN network 171 is communicatively coupled to the Internet backbone network 197. A second direct data pathway between the EPD 111 and the EPD 121 running via the SP-AP 163 passes through the WLAN interface 115 of the EPD 111, the downstream WLAN downstream interface 135 of the client AP 131, the wWAN upstream interface 133 of the client AP 131, the wWAN downstream interface 167 of the SP-AP 163, the PS-SPN 161, the Internet backbone network 197, the PS-SPN 171, the data network interface 175 of the SP-AP 173, the upstream DN interface of the client AP 141, the downstream WLAN interface 145 and the WLAN interface 123 of the EPD 121. Encapsulation, formatting and/or coding of the data delivered via the second direct data pathway from the EPD 111 follows a WLAN protocol structure (say, IEEE 802.11 protocol) and next a wWAN protocol structure (say, IEEE 802.20 protocol) during upstream movement towards the Internet backbone network 197 and follows a data network protocol (say, PSTN protocol) and next a WLAN protocol (say, a proprietary standard supporting packet data communication) during downstream movement towards the destination EPD 121.

Varieties of protocols that are supported by the EPDs (111 and 121), the client APs (131, 141 and 151) and the SP-APs (163, 173, 183 and 193) for data communication may be communicatively incompatible. Alternately the EPDs, the client APs and the SP-APs may support identical protocols that operate in a substantially non-competitive manner for example, these identical protocols may be operating in different frequency bands. Each upstream and downstream communication interface of the EPDs, the client APs and the SP-APs operates pursuant to an industry or proprietary communication standard. “Downstream” and “upstream” do not refer to actual direction of data flow, but refer to relative location of a device (i.e., an EPD, a client AP or an SP-AP) with respect to the Internet backbone network 197.

A client AP 151 has one upstream data network (DN) communication interface 153 and two downlink communication interfaces, a wireless link interface 157 and a wired link interface 159. The client AP 151 interacts with the Internet backbone network 197 via SP-AP 193. In this exemplary case the client AP 151 is communicatively connected to two different communication interfaces (the wireless link interface 127 and the wired link interface 128) of the EPD 121 via its two downlink communication interfaces. The client AP 151 may decide to use and/or may be directed to use any one or both of the two downlink communication interfaces to send data and/or receive data from the EPD 121. The EPD 121 with its four communication interfaces may choose to send data to the EPD 111 via either the client AP 141, or the SP-AP 183 or the client AP 151.

The EPD 111 and the EPD 121 may communicate with each other via a plurality of pathways. Each of the EPDs 111 and 121 has a plurality of paths to reach a “selected AP”. As an example the EPD 121 wants to interact with the “selected AP” 141. The EPD 121 may communicate directly with the “selected AP” 141 via the WLAN interface 123, a first wireless link between the EPD 121 and the client AP 141 and the downstream WLAN interface 145. The EPD may alternately or in addition communicate with the “selected AP” 141 via an indirect path that runs through the wired link interface 128, a wired link between the EPD 121 and the client AP 151, the downstream wired link interface 159, the upstream DN interface 153, the downstream DN interface 195, the SP-AP 193, the PS-SPN 191, the Internet backbone network 197, the PS-SPN 171, the SP-AP 173, the downstream DN interface 175 and the upstream DN interface 143 of the client AP 141. Similarly any of the client APs (131, 141 or 151) and any of the SP-APs (163, 173, 183 and 193) has a direct downstream path to an associated EPD (111 or 121) and at least one indirect upstream path to the associated EPD. As an example the SP-AP 173 may send a data to the EPD 121 via the downstream DN interface 175 and the client AP 141 and/or may direct delivery of the data to the EPD 121 via the Internet backbone network 197 and the SP-AP 183. The data from any of the APs flowing through the indirect upstream path to the associated EPD moves upstream towards the Internet backbone network 197 and then downstream towards the associated EPD via a second AP.

Each of the EPDs 111 and 121 has more than one communication interfaces. The EPDs 111 and 121 typically support a plurality of communication protocols for exchange of data and command packets via respective communication interfaces. As an example the EPD 111 supports WiMax protocol for data communication via its wWAN interface 113 and supports IEEE 802.11 protocol for data communication via its WLAN interface 115. Multiple communication interfaces of each of the EPDs 111 and 121 are implemented with entirely independent circuitry or may share common circuit elements. The PS-SPN 161, the PS-SPN 171, the PS-SPN 181 and the PS-SPN 191 are communicatively coupled to each other via the Internet backbone network 197. Each of the EPDs 111 and 121 is communicatively coupled/associated with more than one access points. As an example, the EPD 121 is associated with the client AP 141, the SP-AP 183 and the client AP 151. Each of the EPDs 111 and 121 has a direct data pathway (i.e., a direct communication route to another EPD) that flows through a first associated AP (or “selected AP”) as well at least one indirect command pathway to the first associated AP via a second associated AP. In addition to flowing through the second associated AP, the indirect command pathway will typically flow through the Internet backbone network 197 to reach the first associated AP. Flowing through the Internet backbone network 197 is not necessary in some situations, however. For example, the indirect command pathway might flow between the first and second associated APs via a service provider's network when both the first and second associated APs are provided by a single packet switched service provider.

More particularly, the EPD 121 has a direct communication path to the SP-AP 183 via the WCS I/F 125 and an indirect communication path to the SP-AP 183 via the client AP 151. In this example, data sent by the EPD 121 travels upstream via the client AP 151 and the SP-AP 193 to the Internet backbone network 197 and then downstream to the SP-AP 183. If the SP-AP 183 and the SP-AP 193 belong to same service provider network, the data sent by the EPD 121 via the client AP 151 need not travel up to the Internet backbone network 197 and may be routed by the SP-AP 193 directly to the SP-AP 183, thereby bypassing the Internet backbone network 197. The at least one indirect command pathway typically flows through the Internet backbone network 197 when the first associated AP and the second associated AP support communicatively incompatible protocols and/or are maintained by different service providers.

Each of the EPDs, (111 and 121) and access points, whether client APs or SP-APs, that are adapted to communicate directly to any of the EPDs (111 and 121) comprises an indirect command generation and processing circuitry (ICGP). The EPD 111 has an ICGP 117, the EPD 121 has an ICGP 129, the client AP 131 has an ICGP 137, the client AP 141 has an ICGP 147, the client AP 151 has an ICGP 155, the SP-AP 163 has an ICGP 165, and the SP-AP 183 has an ICGP 185. The ICGP circuitry carries out two functionalities, an indirect command generation (ICG) functionality and an indirect command processing (ICP) functionality. Any one or both of the ICG and the ICP functionalities may be selectively disabled and re-enabled. The ICGP circuitry is typically a combination of hardware and software. For example, the ICG and ICP may be implemented in general purpose processing circuitry that operates pursuant to ICGP program code. Any general or specific purpose, combined or separate ICG and ICP circuitry and/or software may be employed.

ICGP circuitry of each of the EPDs (111 and 121) uses a direct data pathway for delivery of data and an indirect command pathway for exchanging commands. In particular, for example, the EPD 121 may establish a direct data pathway with some remote EPD (not shown) via the client AP 141 and through the SP-AP 173 and the Internet backbone network 197. The EPD 121 establishes the direct data pathway upon associating with the client AP 141. After establishing the direct data pathway, the EPD 121 may exchange data with the remote EPD.

In addition to the direct data pathway, the EPD 121 may also establish an indirect command pathway through which commands, typically relating to the direct data pathway, are exchanged between the client AP 141 and the EPD 121. Such indirect command pathway, however, does not flow directly between the client AP 141 and the EPD 121. Instead, the indirect command pathway flows from the client AP 141 through another AP, e.g., the client AP 151. In one example, commands originating from the EPD 121 flows from the EPD 121 to the client AP 151, SP-AP 193, Internet backbone network 197, and SP-AP 173 before reaching the client AP 141. Commands originating from the client AP 141 reach the EPD 121 via a reverse direction of the flow.

With a direct data pathway flowing through the SP AP 183, the ICGP circuitry 129 inserts in the destination address field of generated commands (i.e., into each command packet) the unique network identifier of the SP-AP 183. The client AP 151, if part of the indirect command pathway, receives such commands via one of the downstream wireless and wired link interfaces 157 and 159. Based on the destination address (that of the SP AP 183), the client AP 151 routes the command upstream to the Internet backbone network which, in turn, routes such commands downstream to the ICGP circuitry 185 of the SP AP 183. The same indirect command pathway may be used for sending a response or originating and sending other commands from the ICGP circuitry 185 to the ICGP circuitry 129. Although not shown, the Internet backbone network 197 consists of a plurality of network nodes that route the packet there through and toward the destination using the destination address.

Simultaneous use of more than one direct data pathway and/or more than one indirect command pathway may be employed. When available, the ICGP functionality may choose which one or more of the available indirect pathways to use to deliver commands.

Data exchanged between two or more EPDs typically consists of one or combination of real time and/or archived files, program code, and multimedia information such as text, audio, video, picture, movie, video game, and television programs. Commands exchanged via the indirect command pathway typically relate to the direct data pathway. A command may consist of a request, enquiry, or instruction that may involve an adjustment by the recipient or any other type of response. For example, while sending data via a direct data pathway through the SP-AP 183 using the WCS interface 125, the EPD 121 may send a command via an indirect command pathway to the SP-AP 183 using the wireless link interface 127 to the client AP 151. In response to the command received via the client AP 151, SP AP 193 and Internet backbone network 197, the ICGP circuitry 185 invokes corresponding ICG functionality. Such command might be to place the SP AP 183 into sleep mode servicing of the EPD 121. It might be to adjust protocol or other communication parameters. Many other types of commands (originating from either access points or EPDs) and related servicing is possible. As previously mentioned, such commands may be related to any functionality involving: a) security; b) data flow; c) handover; d) association, re-association and disassociation; e) persistent network connectivity; f) power conservation; g) load balancing; h) testing; and i) supplemental information exchange. For example, the command may direct establishing of an alternate direct data pathway. It may direct delivery of pending data to the EPD 121 via a previously busy or sleeping WCS I/F 125. The command may request test packet exchanges or reporting thereon. Other commands request information for monitoring or managing an active direct data pathway and so on.

For example, if the WLAN interface circuitry 123 that supports the direct data pathway is in a sleep mode or is otherwise unavailable, the client AP 141 may generate and send a command to “wake up” the WLAN interface circuitry 123 when the client AP 141 receives data to be delivered to the EPD 121. The command is sent along an indirect command pathway, e.g., from the client AP 141 to the SP AP 173, through the Internet backbone network 197 to the SP AP 183, and, via the WCS interface 187, to the EPD 121.

The client AP 141 receives the command from the SP-AP 173 via the upstream DN I/F 143. Portion of the ICGP circuitry 147 that is responsible for ICP functionality determines that the command is meant for the client AP 141 and subsequently processes the command. The client AP 141 is hence aware of the fact that the control signal to the EPD 121 is not to be sent to the EPD 121 via the downstream WLAN interface 145 of the client AP 141. The indirect command pathway between the EPD 121 and the client AP 141 (“selected AP”) in this example passes through the client AP 151. ICG functionality of the ICGP circuitry 129 of the EPD 121 and ICP functionality of the ICGP circuitry 147 of the client AP 141 jointly manage transmission, flow and reception of the command (i.e., the request from the EPD 121) via the indirect command pathway.

The EPD 121 is uniquely identified by a network address. The client AP 141 knows the network address of the EPD 121. The client AP 141 may decide to respond to the command received via the indirect command pathway by sending the control data to the EPD 121 via the indirect command pathway. In another embodiment the client AP 141 may select a second indirect pathway to the EPD 121 for delivery of the control data. The ICG portion of the ICGP circuitry 147 of the client AP 141 directs the control data to be appended with the network address of the EPD 121 as destination address and then directs transmission of the control data via the upstream DN I/F 143. The control data with the network address of the EPD 121 appended to it travels upstream via the SP-AP 173 to the Internet backbone network 197. The Internet backbone network 197 routes the control data to the PS-SPN 191. The control data next travels downstream and reaches the SP-AP 193. The client AP 151 receives the control data fro the SP-AP 193 via the upstream DN I/F 153. The client AP 151 from the destination address of the control data decides that the control data is meant for the EPD 121. The client AP 151 forwards the control data to the EPD 121. The EPD 121 ultimately receives the control data via the wired link I/F 128. The ICP portion of the ICGP circuitry 129 of the EPD 121 subsequently processes the control data. In this example the client AP 141 sends the command data i.e., the control data to the EPD 121 via the indirect command pathway that passes through client AP 151. ICG functionality of the ICGP circuitry 147 of the client AP 141 and ICP functionality of the ICGP circuitry 129 of the EPD 121 jointly manage transmission, flow and reception of the command (i.e., the control data) via the indirect command pathway. The command i.e., the control data in this example keeps the sleeping EPD 121 communicatively associated with the client AP 141.

In yet another embodiment, the EPD 121 may want to know if there is any data at the SP- AP 183 awaiting transmission to the EPD 121 while the WCS I/F of the EPD 121 is in “sleep mode”. The ICGP circuitry 129 of the EPD 121 evokes the ICG functionality. The ICGP circuitry 129 directs transmission of a command comprising an enquiry for pending data at the SP-AP 183 via WLAN I/F 123 of the EPD 121. The command comprising the enquiry travels via the client AP 141, the PS-SPN 171, the Internet backbone network 197 and the CS-SPN 181 to finally reach the SP-AP 183. The EPD 121 may want to get associated with the client AP 131 with which it is not associated currently. The EPD 121 has no direct pathway to the client AP 131. The EPD 121 decides to send an association request to the client AP 131 via the SP-AP 183. The ICGP circuitry 129 of the EPD 121 directs transmission of the command (i.e., the association request) via the WCS I/F 125 of the EPD 121. The indirect command pathway in this example may comprise the SP-AP 183, the Internet backbone network 197, the SP-AP 163 and the upstream wWAN I/F 133 of the client AP 131. The command travels via the indirect command pathway to reach the client AP 131. Similarly the command may include a disassociation request from the EPD 121 to the client AP 141, a handover request from the EPD 111 for handover from the client AP 131 to the client AP 141.

The EPD 111 (as well the EPD 121) and a “selected AP” may exchange an enquiry and subsequent response information via the indirect command pathway when the direct data pathway between the EPD 111 and the “selected AP” is not available. The EPD 111 and/or the “selected AP” may in addition choose the indirect command pathway for delivery of the command when the direct data pathway between the EPD 111 and the “selected AP” does not support required quality of service, required robustness against eavesdropping and/or the direct data pathway becomes overloaded or delay in the direct data pathway exceeds a predefined limit. Any of the EPDs 111 and 121 has a first indirect pathway and a second indirect pathway to the client AP 151. The first indirect pathway passes through the client AP 141 and the second indirect pathway passes through the SP-AP 183. The ICGP circuitry 129 selects one from the first indirect pathway and the second indirect pathway and directs delivery of the command via the selected indirect pathway the client AP 151.

Any of the APs (the client APs and SP-APs) send command to a “destination EPD” via an indirect command pathway while it sends data to the “destination EPD” via a direct data pathway. The indirect command pathway passes through a second AP with which the “destination EPD” is currently communicatively associated. The AP uses the indirect command pathway to deliver the command to the “destination EPD” either because it may have been instructed to do so by the “destination EPD” or for example, when the AP finds the direct data pathway to the “destination EPD” unreliable. As an example the client AP 131 has a direct data pathway to the EPD 111 via the downstream WLAN I/F 135 and has an indirect command pathway to the EPD 111 via the SP-AP 163. The client AP 131 may lose connectivity to the EPD 111 via the direct data pathway at an instant of time. Such situation may typically arise when the EPD 111 moves out of coverage range of the client AP 131. In such a case, the client AP 131 may send a control signal or a re-association request to the EPD 111 via the indirect command pathway. The indirect command pathway to the “destination EPD” may not pass through the Internet backbone network 197.

The command sent by the EPD 121 to the client AP 151 via the indirect command pathway i.e., via the WCS I/F 125 and the SP-AP 183 may comprise protocol information corresponding to the wired link protocol used by the wired link I/F 128 of the EPD 121 to communicate directly with the client AP 151. The command from the EPD 151 to the client AP 151 may comprise, for example, an increased bandwidth allocation request corresponding to the direct data pathway to the client AP 151, status information corresponding to the wired link I/F 128 of the EPD 121, a power adjustment request effecting an increase/decrease in power of the downstream wired link I/F 159 of the client AP 151 etc. The command may consist, for example, of one or more of a request, an enquiry, a control message and a instruction that invokes a processing on one or more of the downstream wired link I/F 159 of the client AP 151 the direct data pathway between the EPD 121 and the client AP 151 and the wired link I/F 128 of the EPD 121.

In another variant of the present invention the ICGP circuitry 137 of the client AP 131 decides to send a special-purpose data to the EPD 111 via an indirect pathway instead of sending via a direct data pathway comprising the downstream WLAN I/F 135 of the client AP 131 and the WLAN I/F 115 of the EPD 111. As a way of example the client AP 131 (i.e., the ICGP 137) sends a wake up command to the EPD 111 via the indirect pathway to wake up the hitherto sleeping WLAN I/F 115 of the EPD 111. The client AP 131 sends data to the EPD 111 via the direct data pathway i.e., via the downstream WLAN I/F 135 of the client AP 131 and the WLAN I/F 115 of the EPD 111 once the WLAN I/F 115 of the EPD 111 wakes up in response to the wake up command from the client AP 131. The client AP 131 (i.e., the ICGP 137 may direct to send) may send a protocol and/or a power adjustment request corresponding to the direct data pathway to the EPD 111 via the indirect pathway even when the WLAN I/F 115 of the EPD 111 is operative. The EPD 111 responds to the protocol and/or the power adjustment request by adjusting protocol parameter setting of the WLAN I/F 115 and/or by adjusting power of the WLAN I/F 115. The WLAN I/F 115 of the EPD 111 continues exchanging data with the client AP 131 via the WLAN I/F 115 i.e., via the direct data pathway with adjusted protocol parameter setting and/or adjusted WLAN I/F 115 power. The ICGP circuitry 137 of the client AP 131 may direct transmission of a pathway information i.e., traffic information, allocated bandwidth information, available bandwidth information, current data transfer rate information, interference level information corresponding to the direct data pathway, a status information corresponding to the client AP 131 etc. to the EPD 111 via the indirect pathway instead of directing transmission via the direct data pathway. ICG functionality of the ICGP circuitry 137 of the client AP 131 decides to direct the special-purpose data via the indirect pathway based on or irrespective of the status of the WLAN I/F 115 of the EPD 111. The indirect pathway from the client AP 131 to the EPD 111 may for example, pass through the SP-AP 173 and the wWAN I/F 113 of the EPD 111. ICP functionality of the ICGP circuitry 117 of the EPD 111 directs the wWAN I/F 113 to receive the special-purpose data arriving via the indirect pathway.

Many other types of commands and command processing are contemplated. For example, security related commands relating to a direct data pathway might involve exchange of public or private keys or encrypted information via the indirect command pathway. Data flow related commands might involve altering routing tables. Graceful disassociation from a direct data pathway, when a direct data pathway is out of range or otherwise unavailable may be accomplished using a detach command sent via the indirect command pathway. Test commands and associated performance information gathering related to the direct data pathway may be exchanged via the indirect command pathway.

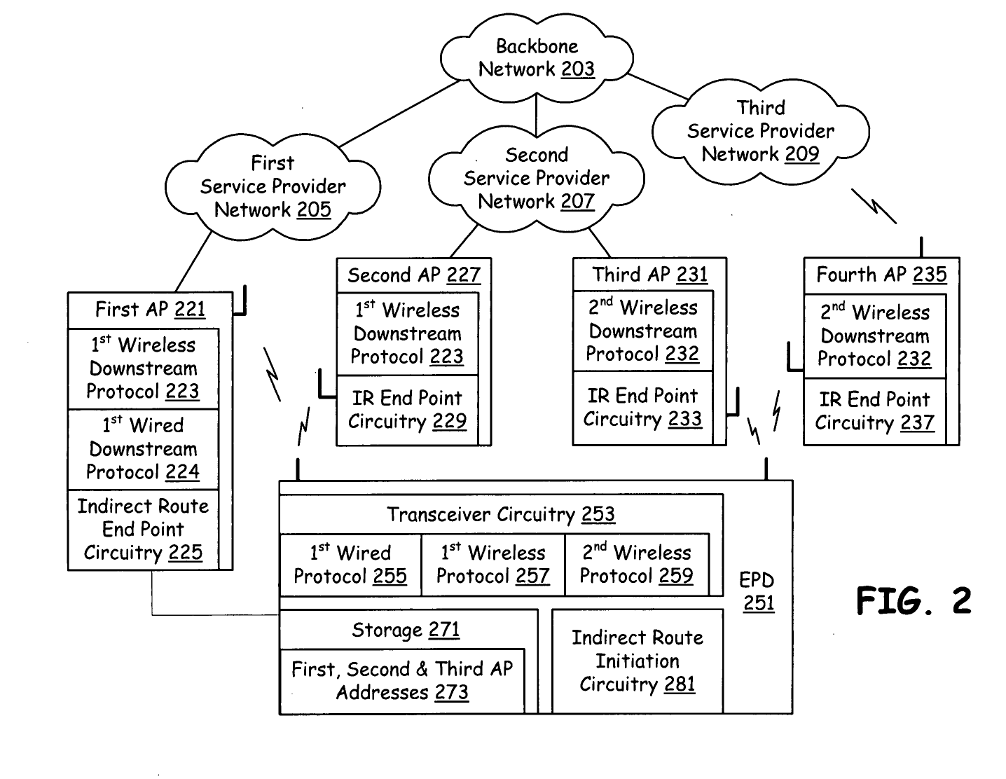

FIG. 2 is a schematic block diagram illustrating an end point device of FIG. 1, the end point device 251 selecting and subsequently using an indirect command pathway for delivery of a command to an associated access point. The end point device (EPD) 251 comprises a transceiver circuitry 253. The transceiver circuitry 253 comprises a first radio 255 that supports a wired packet switched data protocol 224, a second radio 257 that supports a first wireless packet switched data protocol 223 and a third radio 259 that supports a second wireless packet switched data protocol 232. The first wireless protocol and the second wireless protocol may be any of an IEEE 802.11 protocol, an IEEE 802.16 protocol, a Bluetooth, an IEEE 802.20 protocol, a CDMA, a WCDMA, a GSM, a GPRS and an EDGE. The EPD 251 is adapted to support three simultaneous packet data communication via the first radio 255, the second radio 257 and the third radio 259. A first AP 221 supports the first wireless protocol 223 and the wired protocol 224, a second AP 227 supports the first wireless protocol 223, a third AP 231 supports the second wireless protocol 232 and a fourth AP 235 supports the second wireless protocol 232. The EPD 251 is located within communication range of the first AP 221, the second AP 227, the third AP 231 and the fourth AP 235. The first AP 221 is communicatively connected to backbone network 203 via a first service provider network 205, the second AP 227 and the third AP 231 are communicatively connected to the backbone network 203 via a second service provider network 207 and the fourth AP 235 is communicatively connected to the backbone network 203 via a third service provider network 209.

As a way of example the EPD 251 is communicatively coupled to the first AP 221, the second AP 227 and the third AP 231. The EPD 251 sends and receives data packets from the first AP 221 via the first radio 255 using the wired protocol 224. The EPD 251 sends and receives data packets from the second AP 227 via the second radio 257 using the first wireless protocol 223. In addition the EPD 251 sends and receives data packets from the third AP 231 via the third radio 259 using the second wireless protocol 232. The EPD 251 has a first upstream pathway to the backbone network 203 via the first AP 221, a second upstream pathway to the backbone network 203 via the second AP 227 and a third upstream pathway to the backbone network 203 via the third AP 231. The first AP 221, the second AP 227 and the third AP 231 are uniquely identified by a first AP address, a second AP address and a third AP address respectively. The EPD 251 stores AP addresses 273 of the EPD 251. The EPD 251 comprises an indirect route initiation circuitry (IRIC) 281 that initiates selection and transmission of the command data packet to any of the first AP 221, the second AP 227 and the third AP 231 via an indirect pathway. The indirect pathway is henceforth called the indirect command pathway as the indirect pathway carries the command data packet.

The data packets sent and received by the EPD 251 from either of the first AP 221, the second AP 227 and the third AP 231 comprise one or more of an audio, text, video, picture, music file, photo, television program, webpage, streaming video, movie, live and/or archived multimedia information. The EPD 251 may be one of a television, a phone, a notebook, a personal computer, a PDA, a game box, a headphone, a server etc. The EPD 251 exchanges the data packets with the third AP 231 using the third radio 259 and the second wireless protocol 232. The command data packet sent by the EPD 251 to, for example, the third AP 231 comprises a request, an enquiry and/or an instruction to be carried out by the third AP 231 resulting in a change in status and/or parameters of the first radio 255, the second radio 257 and/or the third radio 259 of the EPD 251, a change in a direct data communication link between the EPD 251 and the third AP 231, a change in status and/or parameters of the third AP 231 etc. As an example, the command data packet sent to the third AP 231 via the indirect command pathway comprises a pending data packet enquiry when the third radio 259 is in sleep mode i.e., the third radio 259 is not exchanging data packets with the third AP 231 via the direct communication link. The third AP 231 responds to the pending data packet enquiry from the EPD 251 by requesting the EPD 251 to wake up the third radio 259 in order to receive data packets that are waiting in the third AP 231 via the direct data communication link. The command data packet in the example causes change in status of the third radio 259 from the sleep mode to the wake up mode. If there are no pending data packets in the third AP 231 then the third AP 231 informs the EPD 251 about absence of pending data packets. The third AP 231 sends response to the pending data packet enquiry to the EPD 251 via the indirect command pathway and/or another indirect pathway because the third radio 259 of the EPD 251 is in sleep mode. The third AP 231 decides the pathway to be used for delivery of the response to the EPD 251.

As an example, the command data packet sent to the third AP 231 via the indirect command pathway comprises a pathway information request corresponding to the third upstream pathway between the EPD 251 and the backbone network 203 when the third radio 259 is in wake up mode i.e., the third radio 259 is exchanging data packets with the third AP 231 via the direct data communication link. The IRIC 281 of the EPD 251 chooses to use the indirect command pathway for sending the pathway information request to the third AP 231 in order to not increase traffic load on the direct communication link. The pathway information corresponding to the third upstream pathway typically comprises current interference and current delay in the third upstream pathway, maximum data rate supported by the third upstream pathway etc. The third AP 231 receives and/or measures the pathway information corresponding to the third upstream pathway and stores the information in a memory of the third AP 231. In response to the pathway information request received via the indirect command pathway, the third AP 231 delivers the pathway information stored in the memory to the EPD 251 via the indirect command pathway and/or another indirect pathway. The EPD 251 decides to continue using the third radio 259 and/or other radios of the EPD 251 (i.e., the first radio 255 and the second radio 257) to send the data packets to the backbone network 203 depending on the pathway information the EPD 251 receives from the third AP 231. The EPD 251 may alternately or in addition decide to increase/decrease transmit power of the third radio 259 in response to the pathway information. The command data packet sent to the third AP 231 via the indirect command pathway causes a change in status of the third radio 259 in this exemplary case.

The IRIC 281 of the EPD 251 selects the indirect command pathway via which the command data packet reaches the third AP 231 from the EPD 251. The EPD 251 has a first indirect pathway and a second indirect pathway from the EPD 251 to the third AP 231. The first indirect pathway comprises the first radio 255, the first AP 221, the first service provider network 205, the backbone network 203, the second service provider network 207 and the third AP 231. The IRIC 281 of the EPD 251 directs transmission of the command data packet with the third AP address appended to it via the first radio 255 if the IRIC 281 selects the first indirect path for transmission of the command data packet. The third AP address is appended to the command data packet so that the command data packet gets routed properly by nodes during its movement along the first indirect pathway. The first radio 255 sends the command data packet to the first AP 221 using the wired protocol 224. The first AP 221 and the first service provider network 205 support the wired protocol 224. The command data packet moves upstream from the first radio 255 to the backbone network 203 via the first AP 221 and the first service provider network 205. Structure of the command data packet conforms to the wired protocol 224 during upstream movement. The backbone network 203 forwards the command data packet to the second service provider network 207 by inspecting the third AP address appended to the command data packet. The command data packet travels downstream from the backbone network 203 to the third AP 231 via the second service provider network 207. The command data packet structure follows the first wireless protocol 223 or the second wireless protocol 232 when the command data packet travels from the backbone network 203 to the second service provider network 207. The command data packet is encapsulated as per the second wireless protocol 232 when the command data packet travels from the second service provider network 207 to the third AP 231. The third AP 231 supports the second wireless protocol 232 for receiving and transmitting data packets. The third AP 231 comprises an indirect route end point circuitry (IREPC) 233 that determines that the command data packet appended with the third AP address and arriving via an upstream interface of the third AP 231 is intended for the third AP 231. The IREPC 233 processes the command data packet in/without conjunction with a processing circuitry of the third AP 231 and responds to the command data packet.

The second indirect pathway comprises the second radio 257, the second AP 227, the second service provider network 207 and the third AP 231. The IRIC 281 of the EPD 251 directs transmission of the command data packet with the third AP address appended to it via the second radio 257 and using the first wireless protocol 223 if the IRIC 281 selects the second indirect pathway for transmission of the command data packet. The IRIC 281 selects either of the first indirect pathway and the second indirect pathway depending on current performance of the first indirect pathway and the second indirect pathway. The EPD 251 collects the current performance information from the first AP 221 and the second AP 227 regularly and/or when required by the IRIC 281. The current pathway information may typically include interference, congestion, load, delay etc. on the first indirect pathway and the second indirect pathway. The command data packet travels upstream to the second service provider network 207 via the second radio 257 and the second AP 227. The second service provider network 207 routes the command data packet to the third AP 231. The command data packet is encapsulated pursuant to the second wireless protocol 232 by the second service provider network 207 as the third AP 231 supports the second wireless protocol 232. The IREPC 233 of the third AP 231 processes the command data packet in/without conjunction with the processing circuitry of the third AP 231.

In another embodiment the EPD 251 is communicatively associated with first AP 221 via the first radio 255, with the second AP 227 via the second radio 257 and with the fourth AP 235 via the third radio 259. The EPD 251 wishes to send a second command data packet to the first AP 221. The IRIC 281 of the EPD 251 may select either of a first indirect path via the second AP 227 and a second indirect path via the fourth AP 235 for delivery of the second command data packet. The first indirect path as well the second indirect path runs via the backbone network 203. The IRIC 281 of the EPD 251 appends the first AP address to the second command data packet to ensure routing of the second command data packet via all nodes along the first indirect path as well the second indirect path.

In yet another embodiment the first radio 255 of the EPD 251 is adapted to receive packets but not transmit the packets. As an example, the EPD 251 is communicatively associated with the first AP 221 via the first radio 255 and the fourth AP 235 via the third radio 259. The first AP 221 has a downstream communication path to the EPD 251 while the EPD 251 does not have an upstream communication path to the first AP 221. The EPD 251 in this exemplary case receives data packets and special purpose packets that comprise request, command and/or enquiry from the first AP 221 via the downstream communication path and the first radio 255 using the wired protocol 224. The IRIC 281 of the EPD 251 directs the command data packet meant for the first AP 221 to be appended with the first AP address and sent out via the third radio 259. The command data packet sent out by the third radio 259 of the EPD 251 using the second wireless protocol 232 travels upstream to the fourth AP 235 and further upstream to the third service provider network 209 and next to the backbone network 203. The backbone network 203 forwards the command data packet to the first service provider network 205 that subsequently forwards the command data packet to the first AP 221. Encapsulation and formatting of the command data packet conforms to the second wireless protocol 232 during upstream movement while conforms to the wired protocol 224 during downstream movement. The IREPC 225 of the first AP 221 processes the command data packet that may typically comprise information related to a) handover, b) disassociation, c) association and re-association, d) power consumption, e) current load, f) current delay, g) bandwidth requirement etc. of the EPD 251 and/or the downstream communication path. In this exemplary case the EPD 251, because of unavailability of the upstream communication path to the first AP 221, sends the command data packet to the first AP 221 via the fourth AP 235 and the backbone network 203.

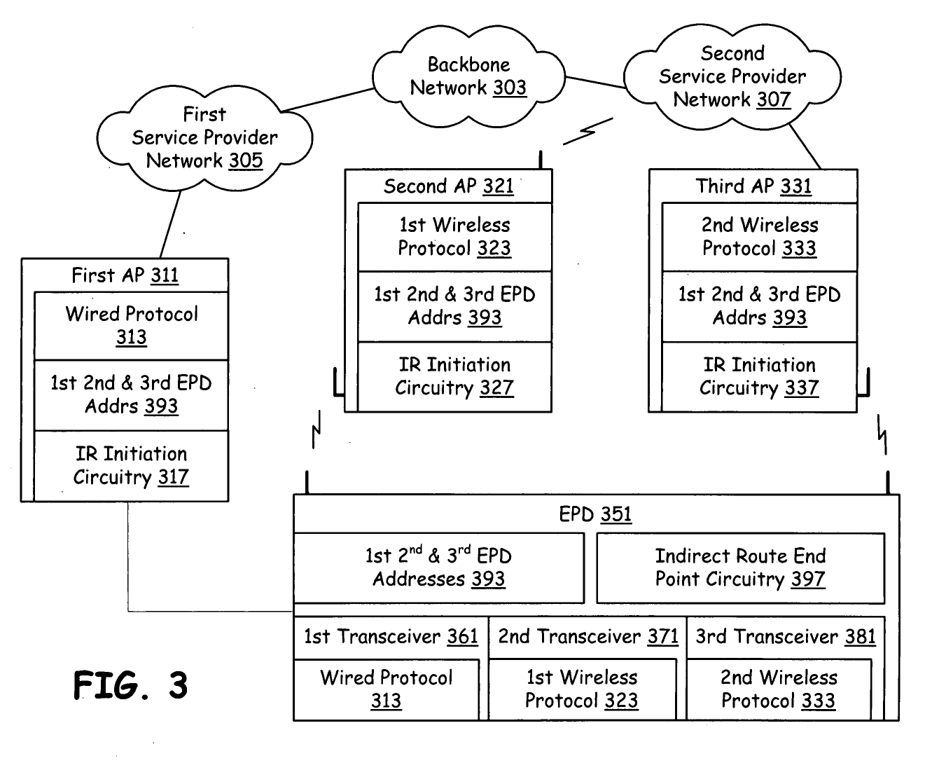

FIG. 3 is a schematic block diagram illustrating a first access point 131 of FIG. 1 initiating delivery of a command to an end point device 351 via a second access point 321 to which the end point device 351 is communicatively coupled instead of using a direct downstream pathway for the delivery of the command to the end point device 351. The first AP 311 operates pursuant to a wired protocol 313. The first AP 311 typically comprises an upstream communication interface, a downstream communication interface, processing circuitry and memory or other type of storage. The first AP 311 sends and receives data packets from the EPD 351 via the direct downstream pathway. The direct downstream pathway comprises the downstream interface of the of the first AP 311, a wired link between the first AP 311 and the EPD 351 and first transceiver 361 of the EPD 351. The first transceiver 361 supports the wired protocol 313. The first AP 311 communicates with a first service provider network 305 via the upstream communication interface. The first service provider network 305 is communicatively coupled to an upstream backbone network 303. The first AP 311 interacts with the backbone network 303 via wired communication links.

The backbone network 303 is in addition communicatively coupled to a second service provider network 307. A second AP 321 and a third AP 331 operate under the second service provider network 307. The second AP 321 and the third AP 331 respectively uses a first wireless protocol 323 and a second wireless protocol 333 for exchange of data packets with the EPD 351. The EPD 351 comprises a second transceiver 371 that supports the first wireless protocol 323 and a third transceiver 381 that supports the second wireless protocol 333. The EPD 351 uses the second transceiver 371 to communicate with the second AP 321 while uses the third transceiver 381 to communicate with the third AP 331. Each of the wired protocol 313, the first wireless protocol 323 and the second wireless protocol 333 may be packet switched data protocol or circuit switched data protocol. Typical examples of standard packet switched data protocol are IEEE 802.11, IEEE 802.16, IEEE 802.20, EDGE, Bluetooth etc. Typical example of standard circuit switched data protocol is GPRS etc. The first AP 311, the second AP 321 and the third AP 331 respectively assigns a first EPD address, a second EPD address and a third EPD address to the EPD 351 at beginning of association. The first AP 311, the second AP 321 and the third AP 331 respectively uses the first EPD address, the second EPD address and the third EPD address to send data to the EPD 351. Data refers to real time and/or archived multimedia information. The first AP 311 sets first EPD address as destination address of the data that is destined for the EPD 351 and sends the data to the EPD 351 via the downstream communication interface of the first AP 311. The first AP 311 receives the second EPD address and the third EPD address from the EPD 351 upon association with the EPD 351. The first AP 311 stores three EPD addresses 393. In addition the second AP 321 and the third AP 331 store the three EPD addresses 393. The second AP 321 and the third AP 331 comprises IRIC (Indirect Route Initiation Circuitry) 327 and IRIC 337 respectively. The second AP 321 as well the third AP 331 is adapted to select an indirect path for delivery of a special purpose data to the EPD 351 instead of sending the special purpose data packet to the EPD 351 via a direct downstream pathway. Any indirect path from any of the APs to the EPD 351 is henceforth referred to as indirect command path and any direct downstream path from any of the APs to the EPD 351 is referred to as direct downstream data path because the indirect command path carries the command and/or special purpose data and the direct downstream data path carries the data destined for the EPD 351.

In FIG. 3, the EPD 351 is shown to be communicatively associated with all three APs, the first AP 311, the second AP 321 and the third AP 331. Any of the APs, for example the first AP 311 may not be associated with the EPD 351 in one embodiment. The first AP 311 i.e., the IRIC 317 of the first AP 311 selects an indirect command path and sends a command to the EPD 351 via the selected indirect command path because there is no direct down stream path via which the first AP 31 may reach the EPD 351. The command in this example may typically be an association request to the EPD 351.

The first AP 311 sends the data typically comprising audio, video, photo, multimedia files, text, television programs, music video, movie, live and/or archived information etc. to the EPD 351 via the direct downstream data path to the EPD 351. The first AP 311 encapsulates the data with the first EPD address prior to transmitting the data via the direct downstream data path. An IRIC 317 of the first AP 311 directs command(s) destined for the EPD 351 to be routed via an indirect command path. The command in this example may be routed to the EPD 351 either via the second AP 321 or via the third AP 331. An IRIC 317 of the first AP 311 in one embodiment selects a priori an AP via which the command is to be routed. In the one embodiment the IRIC 317 decides to route the command to the EPD 351 via the second AP 321. Thus the indirect command path in the one embodiment passes via the second AP 321. The IRIC 317 i.e., the first AP 311 encapsulates the command with the second EPD address. The IRIC 317 if aware of a unique network address of the second AP 321 may also append the network address of the second AP 321 to the encapsulated command. The IRIC 317 triggers transmission of the encapsulated command via the upstream communication interface of the first AP 311. The encapsulated command is routed by nodes along its upstream movement to the backbone network 303 via the first service provider network 305. The encapsulated command data packet is forwarded by the backbone network 303 to the second service provider network 307. The second service provider network 307 forwards the encapsulated data packet to the second AP 321 using the network address of the second AP 321 attached to the encapsulated command. The second AP 321 receives the command from the second service provider network 305 via an upstream communication interface of the second AP 321. The second AP 321 uses the second EPD address to deliver any data directly to the EPD 351 via a downstream communication interface of the second AP 321. The second AP 321 determines that the command is destined for the EPD 351 by inspecting the second EPD address attached to the command. The second AP 321 sends the command to the EPD 351 via the downstream communication interface of the second AP 321. The EPD 351 receives the command via the second transceiver 371. An indirect route end point circuitry (IREPC) 397 of the EPD 351 subsequently processes the command.

In another embodiment the IRIC 317 does not know the network address of the second AP 321. The IRIC 317 is neither aware of a unique network address of the third AP 331. The IRIC 317 in the another embodiment does not decide a priori the AP via which the command data packet is to be routed. In the another embodiment the IRIC 317 of the first AP 311 encapsulates the command with the second EPD address and directs transmission of the encapsulated command via the upstream communication interface of the first AP 311. The encapsulated command travels upstream to the backbone network 303 via the first service provider network 305. The encapsulated command is forwarded by the backbone network 303 to the second service provider network 307. The second service provider network 307 forwards the command to the second AP 321 as well to the third AP 331. The second AP 321 uses the second EPD address to deliver any data directly to the EPD 351 via the downstream communication interface of the second AP 321. The second AP 321 determines that it has to service the encapsulated command by inspecting the second EPD address attached to the encapsulated command. The second AP 321 subsequently sends the command to the EPD 351 via the downstream communication interface of the second AP 321. The third AP 331 determines that the encapsulated command is not to be serviced by it and subsequently discards the command.

The command sent by the first AP 311 to the EPD 351 via the second AP 321 comprises a request, an enquiry, an instruction and/or control information to be subsequently processed by the EPD 351. As an example, the first transceiver 361 is in sleep mode, i.e., the EPD 351 has decided to not use the first transceiver 361 for data communication with the first AP 311 for a predefined time. The first AP 311 receives and/or anticipates receiving data destined for the EPD 351 from the backbone network 303. The first AP 311 wants the first transceiver 361 to wake up and be prepared for receiving the data from the first AP 311 via the first transceiver 361. The IRIC 317 of the first AP 311 sends a wake up request to the EPD 351 via the upstream communication interface of the first AP 311. The IRIC 317 ensures that the command comprising the wake up request is encapsulated with the second EPD address or the third EPD address. The encapsulated command travels via the backbone network 303 and reaches the EPD 351 either via the second AP 321 or the third AP 331 based on address appended to the command. If the IRIC 317 is not aware which of the second transceiver 371 and the third transceiver 381 is operative currently then the IRIC 317 ensures transmission of the command twice, first time the command is encapsulated with the second EPD address and second time the command is encapsulated with the third EPD address. The indirect command path passes through either i) the second AP 321, ii) the third AP 331, or iii) both the second AP 321 and the third AP 331. The EPD 351 receives the command either via the second transceiver 371 or via the third transceiver 381 based on the indirect command path selected by the IRIC 317. The EPD 351 responds to the command by waking up the first transceiver 361. The EPD 351 is now ready to exchange data with the first AP 311 via the first transceiver 361.

As another example, the first AP 311 anticipates receiving no data destined for the EPD 351 from the backbone network 303 for a fixed span of time. The first AP 311 wants the first transceiver 361 to remain in the sleep mode for the fixed span of time. The IRIC 317 of the first AP 311 sends a request to the EPD 351 to this effect via the indirect command path. The EPD 351 receives the request via the indirect command path and responds to the request by putting the first transceiver 361 in the sleep mode for the fixed span of time.

The command in another example comprises an enquiry seeking to know volume of data waiting at the first transceiver 361 for delivery to the first AP 311 and maximum data transmission rate supported by the first transceiver 361. The first AP 311 sends the enquiry to the EPD 351 via the upstream communication interface of the first AP 311 and the third AP 331 while simultaneously receiving data from the EPD 351 via the downstream communication interface of the first AP 311 i.e., via the direct downstream data path. The indirect command path in the another example comprises the upstream communication interface of the first AP 311 and the third AP 331. The IREPC 397 of the EPD 351 responds to the enquiry from the first AP 311 by triggering delivery of length of pending data queue at the first transceiver 361 and the maximum data transmission rate supported by the first transceiver 361 to the first AP 311 via the third transceiver 381 or via the first transceiver 361. The first AP 311 may use the response from the EPD 351 to allocate more bandwidth to the direct downstream data path such that length of pending data queue at the first transceiver 361 decreases quickly i.e., the pending data are transmitted to the first AP 311 via the direct downstream data path of increased bandwidth more quickly.

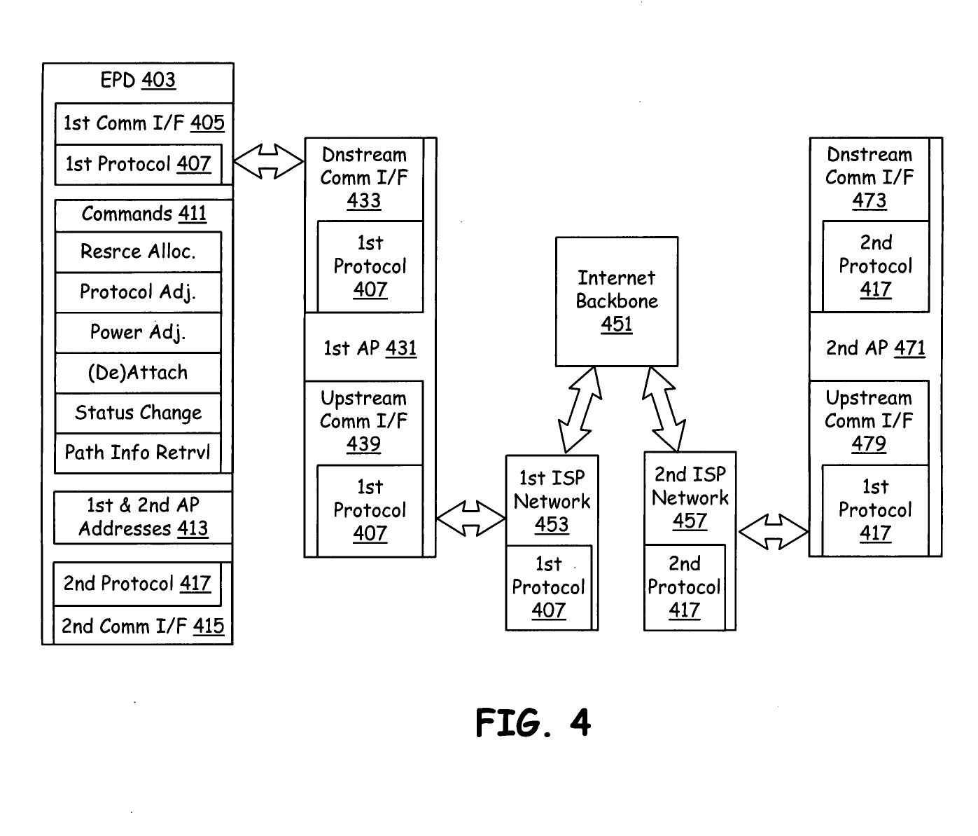

FIG. 4 is a schematic block diagram illustrating a plurality of commands the end point device 251 of FIG. 2 delivers to the associated access point using the indirect command pathway. The EPD 403 comprises a first communication interface 405 that supports data communication using a first protocol 407. The first protocol 407 may be a packet switched data communication protocol or a circuit switched data communication protocol. The EPD 403 has a first direct upstream data pathway to a first AP 431. The first direct upstream data pathway comprises the first communication interface 405, a first communication link between the EPD 403 and the first AP 431 and a downstream communication interface 433 of the first AP 431. The downstream communication interface 433 supports data communication using the first protocol 407. The EPD 403 has a second communication interface 415 that supports data communication using a second protocol 417. The second protocol 417 may be a packet switched data communication protocol or a circuit switched data communication protocol. The EPD 403 has a second direct upstream data pathway to a second AP 471. The second direct upstream data pathway comprises the second communication interface 415, a second communication link between the EPD 403 and the second AP 471 and a downstream communication interface 473 of the second AP 471. The downstream communication interface 473 supports the second protocol 417. The first protocol 407 and the second protocol 417 are one or more of a wired, a wireless terrestrial, a cellular and a wireless satellite data protocol.

The first AP 431 is communicatively connected to a first Internet Service Provider (ISP) network 453 via an upstream communication interface 439 of the first AP 431. The upstream communication interface 439 and the first ISP network 453 i.e., all nodes belonging to the first ISP network 453 support data communication using the first protocol 407. The second AP 471 is communicatively connected to a second ISP network 457 via an upstream communication interface 479 of the second AP 471. The upstream communication interface 479 and the second ISP network 457 support data communication using the second protocol 417. The first ISP network 453 and the second ISP network 457 are communicatively connected to an Internet backbone 451. The EPD 403 is adapted to interact with the Internet backbone 451 via the first AP 431 and using the first protocol 407. In addition the EPD 403 is adapted to interact with the Internet backbone 451 via the second AP 471 and using the second protocol 417.

The first AP 407 and the second AP 417 are uniquely identified by a first AP address and a second AP address respectively. The EPD 403 uses the first AP address and the second AP address to communicate directly with the first AP 407 and the second AP 417 respectively. Direct communication to the APs 407 and the 417 refer to sending data via the first direct upstream data pathway and the second direct upstream data pathway. The EPD 403 stores the first AP address and the second AP address in the EPD 403. There is the indirect command pathway between the EPD 403 and the second AP 471 in addition to the second direct upstream data pathway between the EPD 403 and the second AP 471. The indirect command pathway comprises the first direct upstream data pathway between the EPD 403 and the first AP 431, the upstream communication interface 439 of the first AP 431, the first ISP network 453, the Internet backbone 451, the second ISP network 457 and the upstream communication interface 479 of the second AP 471. The EPD 403 uses the second direct upstream data pathway to send and receive data from the second AP 471 while uses the indirect command pathway to send command to the second AP 471. The command comprises typically a resource allocation request, a protocol adjustment request, a power adjustment request, an attach and/or detach instruction, a status enquiry, a pathway information retrieval command etc. to the second AP 471. The second AP 471 responds to the command by typically actuating a change in the EPD status, a change in the second direct upstream data pathway characteristics etc. The EPD 403 sends the command to the second AP 471 via the first AP 431 to control interaction of the first AP 431 with the EPD 403.

As an example, the EPD 403 exchanges data with the second AP 471 via the second direct upstream data pathway. The EPD 403 wishes to detach from the second AP 471. The EPD 403 sends a detachment request to the second AP 471 via the indirect command pathway. The second AP 471 receives and responds to the detachment request by detaching from the EPD 403 i.e., withdrawing communication association with the EPD 403. The command may be an EPD status notification message to the second AP 471. The EPD 403 wishes to put the second communication interface 415 to sleep mode i.e., the EPD 403 desires to stop data exchange via the second communication interface 415 for a predefined time span. The EPD 403 chooses to inform the second AP 471 about intended change in status of the second communication interface 415 by sending the EPD status notification message to the second AP 471 via the indirect command pathway. The second AP 471 receives and responds to the EPD status notification message by finding an alternate pathway for data exchange with the EPD 403 or withholding data communication with the EPD 403 for the predefined time span and/or aborting data communication with the EPD 403. The command (i.e., the EPD status notification message) sent to the second AP 471 via the indirect command pathway causes abortion of data exchange along the second direct upstream data pathway for at least the predefined time span. As another example, the second communication interface 415 of the EPD 403 is in sleep mode. The EPD 403 desires to keep the second communication interface 415 in the sleep more for a period longer than the predefined time span. The EPD 403 sends a command to the second AP 471 to this effect via the indirect command pathway.

In yet another example, the EPD 403 exchanges data with the second AP 471 via the second direct upstream data pathway and the second communication interface 415. The EPD 403 sends a bandwidth allocation request to the second AP 471 via the indirect command pathway when number of data waiting at the EPD 403 for upstream delivery to the second AP 471 exceeds a preset threshold. The EPD 403 chooses the indirect command pathway for delivery so as not to interrupt and/or eat up bandwidth on the second direct upstream data pathway. The second AP 471 receives the bandwidth allocation request via the indirect command pathway from the EPD 403 and responds by allocating more bandwidth to the second direct upstream data pathway. The command (i.e., the bandwidth allocation request) sent to the second AP 471 via the indirect command pathway in this example causes an increase in bandwidth of the second direct upstream data pathway. The EPD 403 appends the second AP address to the command prior to sending the command via the indirect command pathway. The command encounters a plurality of nodes while traveling along the indirect command pathway. Each of the plurality of nodes reads the second AP address appended to the command, decides a next node based on the second AP address, and forwards the command to the next node. This process of forwarding continues until the command reaches the second AP 471. The first ISP network 453 and the second ISP network 457 may or may not be maintained by same service provider. The first protocol 407 may or may not be communicatively compatible with the second protocol 417.

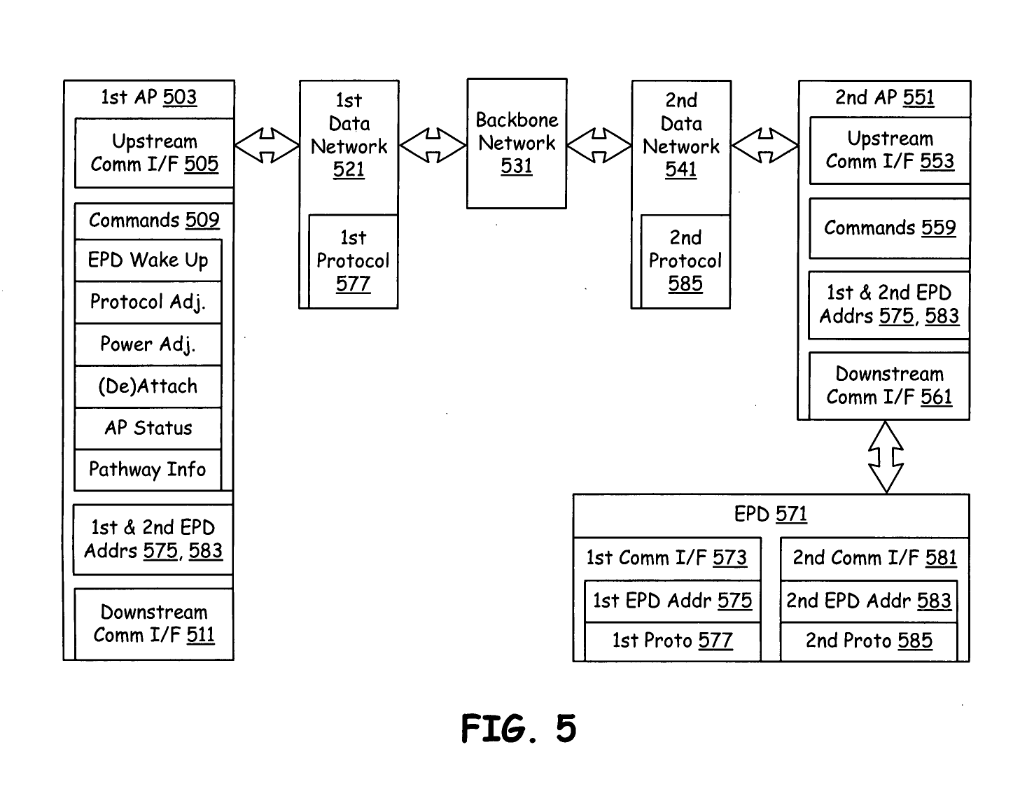

FIG. 5 is a schematic block diagram illustrating a plurality of commands the first access point 311 of FIG. 3 delivers to the end point device 571 using a pathway via the second access point 551. The first AP 503 has a direct downstream communication pathway with the EPD 571. The first AP 503 sends data destined for the EPD 571 via the direct downstream communication pathway to the EPD 571. The direct downstream communication pathway is alternately referred to as direct downstream data pathway. The direct downstream data pathway comprises a downstream communication interface 511 of the first AP 503, a first communication interface 573 of the EPD 571 and a wired and/or a wireless communication link between the downstream communication interface 511 and the first communication interface 573. The first AP 503 and the EPD 571 communicate using a first protocol 577. If the first protocol 577 supports data transmission and reception wirelessly then the communication link between the downstream communication interface 511 and the first communication interface 573 is a wireless link. The first AP 503 has an upstream communication interface 505. The first AP 503 is adapted to receive and send data to backbone network 531 via the upstream communication interface 505. The data sent to the backbone network 531 via the upstream communication interface 505 travels through a first data network 521. All nodes belonging to the first data network 521 support the first protocol 577. The first data network 521 may support either packet switched communication or circuit switched communication.

The backbone network 521 is in addition communicatively coupled to a second data network 541 that supports a second protocol 585. The second protocol 585 is one or more of a wired, a wireless terrestrial, a cellular and a wireless satellite data protocol. A second AP 551 belongs to the second data network 541. The second AP 551 interacts with the backbone network 521 via the second data network 541 via an upstream communication interface 553. The second AP 551 in addition comprises a downstream communication interface 561 via which the second AP 551 is communicatively coupled to the EPD 571. The second AP 551 exchanges data with the EPD 571 via a second direct downstream communication pathway or alternately called a second direct downstream data pathway. The second direct downstream data pathway comprises the downstream communication interface 561 of the second AP 551, a second communication interface 581 of the EPD 571 and a wired and/or a wireless communication link between the downstream communication interface 561 and the second communication interface 581. The second AP 551 follows the second protocol 585 for upstream communication with the backbone network 521 as well for downstream communication with the EPD 571. The first protocol 577 and the second protocol 585 may be communicatively incompatible. The first data network 521 and the second data network 541 may be maintained by different service providers.

The first AP 503 sends data to the EPD 571 via the first direct downstream data pathway. The first AP 503 has an indirect communication path to the EPD 571. The indirect path comprises the upstream communication interface 505, the first packet switched network 521, the backbone network 531, the second packet switched network 541, the upstream communication interface 553 of the second AP 551, the downstream communication interface 561 of the second AP 551 and the second communication interface 581 of the EPD 571. The first AP 503 delivers command to the EPD 571 via the indirect communication path. The indirect communication path from the first AP 503 to the EPD 571 is alternately referred to as indirect command path. The command meant for the EPD 571 and transmitted by the first AP 503 via the upstream communication interface 505 of the first AP 503 moves upstream to the backbone network 531 and then moves downstream via the second AP 551 to the EPD 571. Encapsulation and/or formatting of the command follow the first protocol 577 during upstream movement and follow the second protocol 585 during downstream movement. The first AP 503 identifies the EPD 571 by a unique first EPD address 575 and the second AP 503 identifies the EPD 571 by a unique second EPD address 583. The first AP 503 appends data destined for the EPD 571 with the first EPD address 575 prior to transmitting them via the first direct downstream data pathway. The second AP 551 appends data destined for the EPD 571 with the second EPD address 583 prior to transmitting them via the second direct downstream data pathway. Each of the first AP 503 and the second AP 551 stores the first EPD address 575 and the second EPD address 583. The first AP 503 appends the command with the second EPD address 583 prior to transmitting them via the upstream communication interface 505. The command reaches the second AP 551 traveling via the indirect command path. The second AP 551 determines that the second AP 551 has to send the command to the EPD 571 using the second direct downstream data pathway by observing the second EPD address 583 appended to the command. The command will be ignored by any other AP even if the other AP is communicatively associated with the EPD 571. The command sent by the first AP 503 to the EPD 571 via the indirect command path typically comprises EPD wake up command, power adjustment command, bandwidth allocation command, AP status information, attachment and/or detachment request, first direct downstream data pathway information retrieval request etc.

As a way of example the first AP 503 is interacting with the EPD 571 via the first direct downstream data pathway. The first communication interface 573 of the EPD 571 is in use. The first AP 503 sends a transmit power increase request corresponding to the first communication interface 573 to the EPD 571 via the indirect command path. The EPD 571 receives the transmit power increase request via the second communication interface 581 and responds to the request by increasing transmit power of the first communication interface 573. The response to a command i.e., the request sent by the first AP 503 via the indirect command path causes an increase in signal power level in the first direct downstream data pathway. As another example the command comprises a detach request for the first communication interface 573. The EPD 571 responds to the detach request by directing the first communication interface 573 to stop receiving and transmitting data to the first AP 503 via the first direct downstream data pathway.

The first AP 503 collects pathway information corresponding to an upstream pathway from the first AP 503 to the backbone network 531 regularly and/or as and when required. The pathway information at an instant of time typically comprises current data rate supported, current bit error rate, current level of interference, current delay, cost of data transmission etc., in the upstream pathway. The first AP 503 sends the pathway information to the EPD 571 either regularly and/or when asked for via the indirect command path while simultaneously exchanging data with the EPD 571 via the first direct downstream data pathway. The EPD 571 needs the pathway information to decide future course of actions i.e., the EPD 571 stops transmission via the first communication interface 573, sends data via the first communication interface 573 at an increased/decreased rate, changes transmit power of the first communication interface 573, applies encryption to the data prior to transmission etc., using the pathway information received via the indirect command path. The first AP 503 analyzes the pathway information and determines that the current delay in the upstream pathway has exceeded a predefined threshold. The first AP 503 sends a lower data transfer request corresponding to the first communication interface 573 to the EPD 571 via the indirect command path. The EPD 571 responds to the lower data transfer request by sending out the data via the first communication interface 573 at a decreased rate.

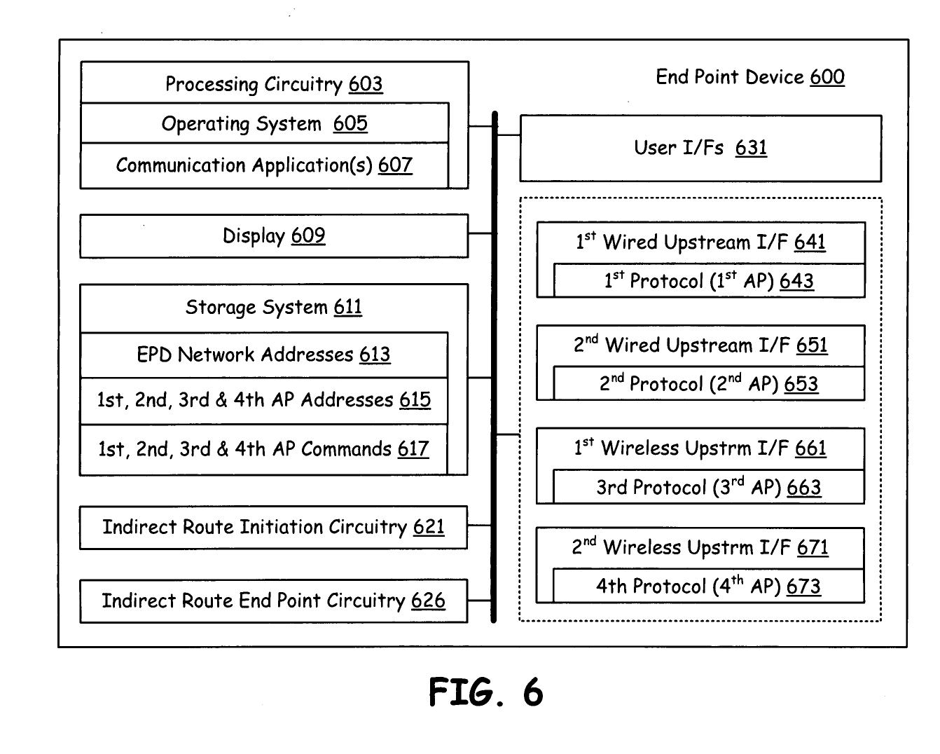

FIG. 6 is a schematic block diagram illustrating a plurality of components of an end point device 600 that supports a direct data pathway to a first access point and an indirect command pathway to the first access point via a second access point, where the end point device 600 uses the indirect command pathway for delivery of a plurality of commands to the first access point. The EPD 600 comprises a processing circuitry 603. An operating system 605 and a communication application 607 runs on the EPD 600. The EPD 600 is for example, a phone, a notebook, a personal computer, a PDA, a headphone, a video game box, a notebook, a server, a client terminal etc. The communication application 607 running on the EPD 600 may be a phone call, a messaging service, an Internet telephony application, a web browsing application, an archived file download application, a video conferencing, an online video game etc., that requires transmission and/or reception of data from one or more data communication network. The EPD 600 comprises a user interface 631. The user interface 631 may typically be a mouse, a keypad, a joystick, a thumbwheel, a touch screen, a plurality of buttons etc. The EPD 600 comprises a first wired upstream interface 641 that supports data communication with the first AP using a first protocol 643. The EPD 600 further comprises a second wired upstream interface 651 that supports data communication with the second AP using a second protocol 653. The EPD 600 has a first wireless upstream interface 661 and a second wireless upstream interface 671 that support data communication with a third AP and a fourth AP respectively using a third protocol 663 and a fourth protocol 673. The first protocol 643, the second protocol 653, the third protocol 663 and the fourth protocol 673 may be communicatively incompatible.

The EPD 600 receives a unique EPD address when the EPD 600 associates itself with any access point. The EPD 600 has four EPD addresses 613 corresponding to four communication associations with the first AP, the second AP, the third AP and the fourth AP. The EPD 600 stores the EPD addresses 613 in a storage system 611 of the EPD 600. Each of the first AP, the second AP, the third AP and the fourth AP are uniquely identified by a first AP address, a second AP address, a third AP address and a fourth AP address respectively. The EPD 600 stores four AP addresses 615 in the storage system 611. The EPD 600 in addition stores a plurality of commands 617 in the storage system 611. The EPD 600 comprises an indirect route initiation circuitry (IRIC) 621 and an indirect route end point circuitry (IREPC) 626.

The EPD 600 exchanges data with the first AP as required by the communication application 607 running on the EPD 600. The EPD 600 encapsulates the data with the first AP address as destination address and in conformity with the first protocol 643 and transmits the data via the first wired upstream interface 641. The plurality of commands 617 are requests, enquiries and/or instructions sent to either of four access points to effectuate a change in interaction of the EPD 600 with corresponding access point. The EPD 600 sends one or more of the plurality of commands 617 to the four access points via indirect routes instead of direct routes. As a way of example the EPD 600 desires to send a command from the plurality of commands to the first AP. The IRIC 621 of the EPD 600 selects the indirect command pathway passing through the second AP to send the command to the first AP. The IRIC 621 directs encapsulation of the command with the first AP address as destination address and in conformity with the second protocol 653. The IRIC 621 directs transmission of the encapsulated command via the second wired upstream interface 651. The encapsulated command reaches the second AP. The second AP reads the destination address of the encapsulated command and forwards the encapsulated command to a next node. The encapsulated command after traveling via one or more data networks reaches the first AP. The first AP determines that the encapsulated command is intended for the first AP by using the destination address. The first AP subsequently processes the command.

Any of the four access points may send a command and/or a special purpose data to the EPD 600 via indirect route. As an example the fourth AP sends the special purpose data to the EPD 600 via the third AP. The first wireless upstream interface 661 that is communicatively coupled to the third AP receives the special purpose data. The first wireless upstream interface 661 forwards the received data to IREPC 626. The IREPC 626 determines origin of the special purpose data and subsequently processes the special purpose data may comprise request, instruction or query that corresponds to support or management of a) security; b) data flow; c) handover; d) association, re-association and disassociation; e) persistent network connectivity; f) power conservation; g) load balancing; h) testing; and i) supplemental information on direct route between any of the four access points and the EPD 600.

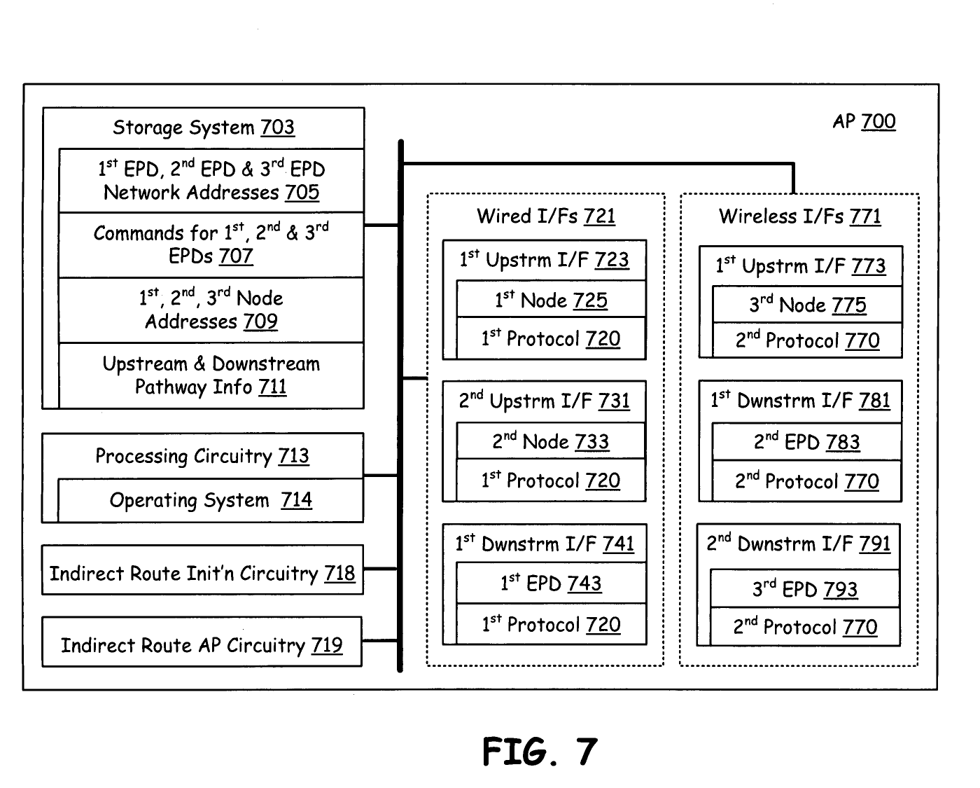

FIG. 7 is a schematic block diagram illustrating a plurality of components of an access point 700 that supports a direct downstream pathway and additionally an indirect upstream pathway to an end point device, where the access point 700 uses the indirect upstream pathway for delivery of a command to the end point device. The AP 700 comprises a processing circuitry 713. The AP 700 comprises a plurality of wired interfaces 721 and a plurality of wireless interfaces 771. Few of the wired interfaces 721 support data communication with upstream node(s). A node is, for example, a router, a switch, a modem that is communicatively connected to the AP 700 via a first end and communicatively connected to a backbone network directly and/or indirectly via a second end. Remaining of the wired interfaces 721 support data communication with downstream end point device(s). An EPD is typically a phone, a notebook, a personal computer, a video game box, a server etc. A communication application runs on the EPD. The EPD supports data communication with one or more data networks in conformity with a data communication protocol. The EPD receives and sends data generated by the communication application to the one or more data networks. “Upstream” and “Downstream” respectively refers to location of the node or the EPD with respect to the backbone network and does not refer to actual direction of flow of data. The data networks may be a packet switched data communication network and/or a circuit switched data communication network. The AP 700 has a first wired upstream interface 723 via which the AP 700 is communicatively coupled i.e., associated with a first node 725. The AP 700 has a second wired upstream interface 731 via which the AP 700 is associated with a second node 733. The AP 700 has a first wired downstream interface 741 via which the AP 700 is associated with a first EPD 751. The AP 700 in addition comprises a first wireless upstream interface 773, a first wireless downstream interface 781, and a second wireless downstream interface 791 via which the AP 700 is communicatively connected with a third node 775, a second EPD 783, and a third EPD 793 respectively. Each of the plurality of wired interfaces 721 supports data communication using a first protocol 720 and each of the plurality of wireless interfaces 771 support data communication using a second protocol 770. The first protocol 720 may be communicatively incompatible with the second protocol 770.

The AP 700 assigns unique network addresses to the first EPD, the second EPD and the third EPD at beginning of association. The AP 700 stores the first EPD network address, the second EPD network address and the third EPD network address (collectively 705) in a storage system 703 of the AP 700. Each of the first node, the second node and the third node is uniquely identified by respective network addresses. The AP 700 stores the first node address, the second node address and the third node address (collectively 709) in the storage system 703. The AP 700 comprises an indirect route initiation circuitry (IRIC) 718 and an indirect route end point circuitry (IREPC) 719.

The AP 700 supports data communication with the first EPD 743 via the first wired downstream interface 741. A direct downstream pathway from the AP 700 to the first EPD 743 comprises the first wired downstream interface 741, i.e., a data transmitted by the AP 700 via the first wired downstream interface 741 travels along the direct downstream pathway and reaches the first EPD 743. As a way of example the first EPD 743 is communicatively connected to a second AP that in turn is connected to a fourth node. The first node 725, the second node 733, the third node 775 and the fourth node are communicatively coupled to each other via the backbone network. An indirect upstream pathway from the AP 700 to the first EPD 743 comprises the first upstream wired interface 723, the first node 725, the backbone network, the fourth node, the second AP and the first EPD 743. The IRIC 718 of the AP 700 chooses the indirect upstream pathway for delivery of the command to the first EPD 743 and chooses the direct downstream pathway for delivery of data to the first EPD 743. The data typically comprise text, music, movie, audio, live performance, television program, video game and any of a variety of live and/or archived multimedia information. The command is a special purpose packet that comprises a request, an enquiry, an instruction, and/or control information. Response of the first EPD 743 to the command brings about a change in interaction of the AP 700 with the first EPD 743 via the direct downstream pathway. The AP 700 has a direct downstream pathway and at least one indirect upstream pathway to each of the first EPD 743, the second EPD 783 and the third EPD 793. The at least one indirect upstream pathway may not necessarily pass through the backbone network. The direct downstream pathway includes one of the plurality of downstream interfaces 741, 781 and 791. The at least one indirect upstream pathway includes one of the plurality of upstream interfaces 723, 731 and 773. The IRIC 718 of the AP 700 performs encapsulation and formatting of the command prior to delivering the command via the indirect upstream pathway.

The AP 700 receives command from any of the first EPD 743, the second EPD 783 and the third EPD 793 via any one of the plurality of upstream interfaces 723, 731 and 773. As an example a data arrives from the first EPD 743 at the first downstream wired interface 741 whereas the command(s) arrives from the first EPD 743 at the first upstream wired interface 723. The first upstream wired interface 723 forwards the received command(s) to the IREPC 719 of the AP 700. The IREPC 719 ascertains sender of the command(s). In the example the IREPC 719 determines that the first EPD 743 has sent the command(s). The IREPC 719 processes the command(s) with/without assistance from the processing circuitry 713 of the AP 700. In another embodiment the plurality of wired interfaces 721 and the plurality of wireless interfaces 771 support other data communication protocols in addition to the first protocol 720 and the second protocol 770. Functionalities performed by the AP 700 may be realized in a set top box.

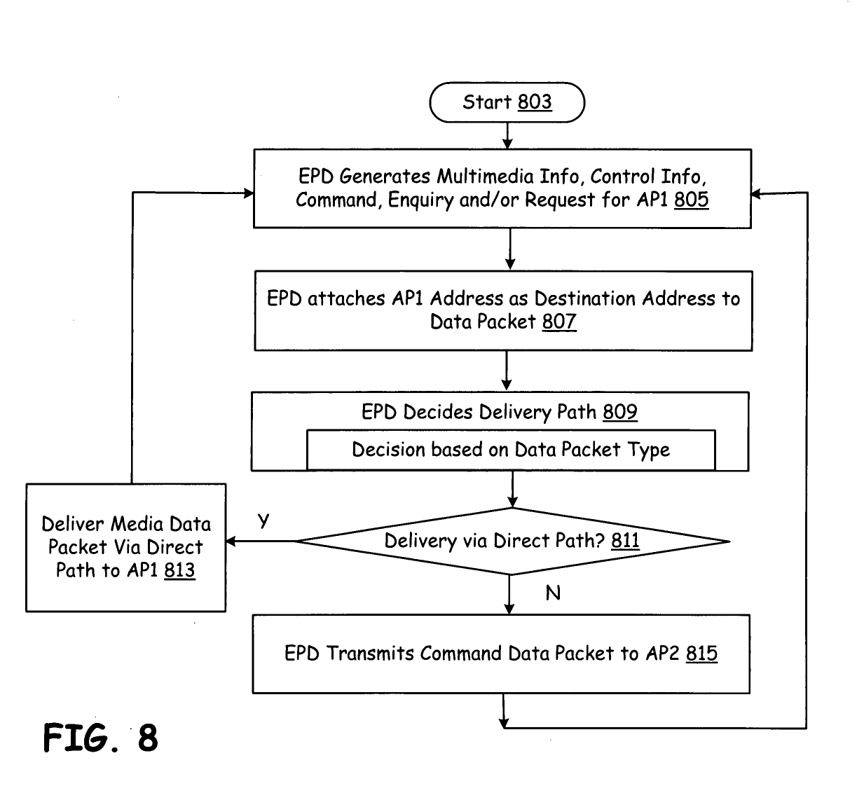

FIG. 8 is a flow chart illustrating a method of selecting a pathway for delivery of a data packet to an access point and subsequent delivery via the selected pathway, where the selection of the pathway by an end point device is based on the data packet type. The method starts at block 803. The EPD is communicatively coupled to a first AP and a second AP. The EPD is adapted to interact with the first AP via a direct communication path and via an indirect communication path. “Direct” refers to the fact that the direct communication path does not include an access point, another EPD and a node such as a modem, router, switch, gateway etc. The indirect communication path between the EPD and the first AP passes through the second AP. In block 805, the EPD generates a data packet intended for the first AP. The first AP and the second AP are identified uniquely by a first AP address and a second AP address respectively. In a next step 807 the EPD attaches the first AP address to the data packet generated in the block 805. The EPD selects a path from the direct communication path and the indirect communication path for delivery of the data packet to the first AP as shown in a block 809. As shown in a block 815, the EPD sends the data packet via the indirect communication path if the data packet typically comprises a request, an enquiry, control information, and/or an instruction that demands subsequent processing by the first AP. The EPD sends such command data packet to the second AP. The command data packet eventually reaches the first AP traveling through the indirect communication path. If the data packet comprises one or more of live and/or archived multimedia information then the EPD selects the direct communication path for delivery of such media data packet as illustrated in a block 813.

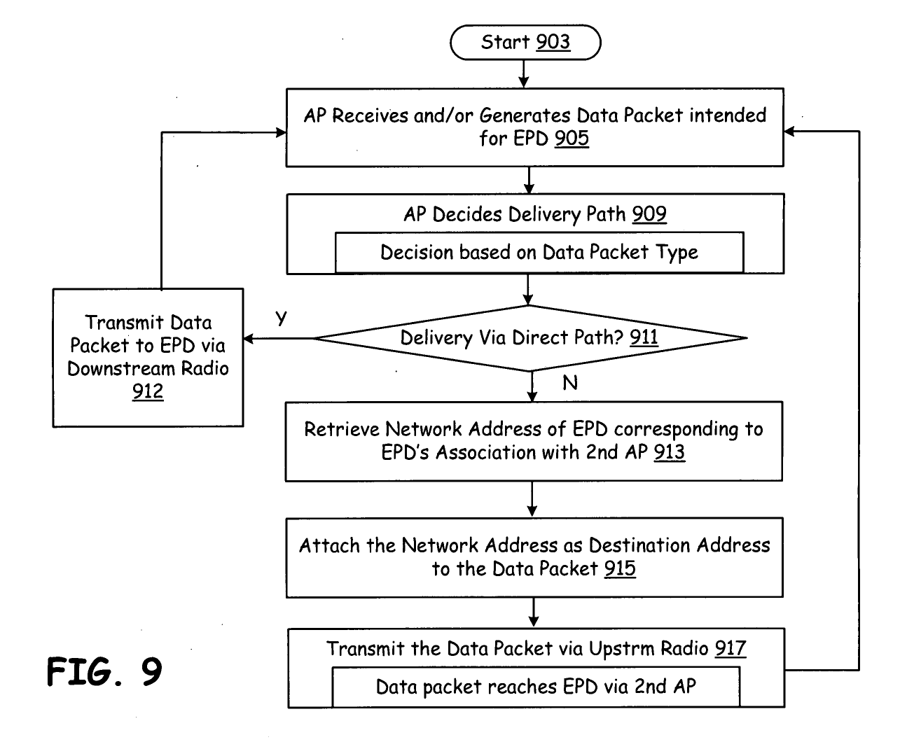

FIG. 9 is a flow chart illustrating a method of selecting a pathway for delivery of data packet to an end point device and subsequent delivery via the selected pathway, where the selection of the pathway by an access point is based on the data packet type. The method starts in block 903. The AP is a transceiver that is communicatively coupled to the downstream EPD via a downstream radio and also communicatively coupled to an upstream node via an upstream radio. The upstream node is in turn connected with a backbone network. The AP is adapted to interact with the EPD via a downstream pathway. Communication via the downstream pathway involves the downstream radio. The downstream pathway is also referred to as a direct pathway to the EPD. The EPD is typically communicatively associated with a second AP that is connected to the backbone network. The AP is adapted to interact with the EPD via an upstream pathway. The upstream pathway passes through the upstream radio, the upstream node, the backbone network, the second AP and the EPD. The upstream pathway is also referred to as an indirect pathway to the EPD.

In block 905 the AP has a data packet ready to be sent to the EPD. The AP may receive the data packet from the upstream node via the upstream radio in one embodiment. The AP may generate the data packet in another embodiment. The data packet may comprise live and/or archived multimedia information. The data packet may alternately be a special purpose packet comprising a request, an enquiry and/or a command that necessitates processing by the EPD resulting in a change in the direct downstream pathway to the EPD. In step 909 the AP selects a pathway from the direct downstream pathway and the indirect upstream pathway for delivery of the data packet. Selection is based on the data packet type. The AP selects the direct downstream pathway for delivery if the data packet comprises live and/or archived multimedia information. The AP transmits such a media containing data packet to the EPD via the downstream radio as illustrated in block 912. The AP selects the indirect upstream pathway for delivery if the data packet is the special purpose packet. The special purpose packet is to be sent to the EPD by the second AP during last leg of journey of the special purpose packet via the indirect upstream pathway. The second AP talks to the EPD using a unique network address. The AP retrieves the unique network address of the EPD in a next step 913. The AP attaches the unique network address to the special purpose data packet as destination address as shown in a next block 915. The AP transmits the special purpose data packet via the upstream radio in block 917. The special purpose data packet ultimately reaches the second AP traveling via the upstream node and the backbone network. The second AP deciphers the destination address of the special purpose data packet, responds to the received special purpose data packet by forwarding the special purpose data packet to the EPD.

As one of average skill in the art will appreciate, the term “communicatively coupled”, as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A communication infrastructure supporting packet switched communications, the communication infrastructure comprising:
a backbone network supporting packet switched communication;
a first wireless area network operating pursuant to a first wireless protocol;
a second wireless area network operating pursuant to a second wireless protocol;
a first access point, communicatively coupled to the backbone network, that manages the first wireless area network;
a second access point, communicatively coupled to the backbone network, that manages the second wireless area network;
an end point device that has both first radio circuitry that uses the first wireless protocol and second radio circuitry that uses the second wireless protocol, the first radio circuitry establishing a direct data pathway via the first wireless area network and the first access point, the second radio circuitry establishing an indirect command pathway between the first access point and the second radio circuitry of the end point device, and the indirect command pathway flowing via the second wireless area network, the second access point, and the backbone network; and
the end point device and first access point exchange a command via the indirect command pathway.

2. The communication infrastructure of claim 1, wherein the exchange of the command comprising delivering the command from the end point device to the first access point via the indirect command pathway.

3. The communication infrastructure of claim 1, wherein the command is delivered from the first access point to the end point device via the indirect command pathway.

4. The communication infrastructure of claim 1, wherein the command relates to secure communication exchanges via the direct data pathway.

5. The communication infrastructure of claim 1, wherein the command comprising a protocol adjustment command.

6. The communication infrastructure of claim 1, wherein the command relates to the direct data pathway.

7. The communication infrastructure of claim 1, wherein the command relates to end point device association.

8. The communication infrastructure of claim 1, wherein the command relates to testing.

9. End point device circuitry in a communication infrastructure, the communication infrastructure further including a backbone network, a first access point and a second access point, the first access point and the second access point are coupled to the backbone network, the end point device circuitry comprising:
first radio circuitry that communicates with the first access point using a first packet switched communication protocol;
second radio circuitry that communicates with the second access point using a second packet switched communication protocol;
processing circuitry, communicatively coupled to the first radio circuitry and the second radio circuitry;
the processing circuitry establishes a direct data pathway to the backbone network via the first radio circuitry and the first access point; and
the processing circuitry exchanges a command with the first access point via an indirect command pathway, the indirect command pathway flowing from the second radio circuitry to the first access point via the second access point and the backbone network.

10. The end point device circuitry of claim 9, wherein the command relates to secure communication exchanges via the direct data pathway.

11. The end point device circuitry of claim 9, wherein the command comprising a protocol adjustment command.

12. The end point device circuitry of claim 9, wherein the command relates to hand over.

13. The end point device circuitry of claim 9, wherein the command relates to access point association.

14. The end point device circuitry of claim 9, wherein the command relates to testing.

15. The end point device circuitry of claim 9, wherein the command relates to load balancing.

16. Access point circuitry in a packet switched communication infrastructure, the communication infrastructure having a backbone network, an first end point device, a second end point device and a secondary access point, the access point circuitry comprising:
upstream communication interface circuitry coupled to the backbone network;
downstream communication interface circuitry coupled to the first end point device;
processing circuitry that maintains a direct data pathway between the first end point device and the second end point device by communicating data between the downstream communication interface circuitry and the upstream communication interface circuitry; and
the processing circuitry, while maintaining the direct data pathway, exchanges a command with the first end point device via an indirect command pathway, the indirect command pathway flowing via the upstream communication interface circuitry, the backbone network and the secondary access point.

17. The access point circuitry of claim 16, wherein the command relates to secure communication exchanges via the direct data pathway.

18. The access point circuitry of claim 16, wherein the command comprising a protocol adjustment command.

19. The access point circuitry of claim 16, wherein the command relates to hand over.

20. The access point circuitry of claim 16, wherein the command relates to end point device association.

21. The access point circuitry of claim 16, wherein the command relates to testing.

22. The access point circuitry of claim 16, wherein the command relates to load balancing.

23. A method performed by a first end point device in a communication infrastructure, the communication infrastructure comprising a first access point, a second access point, and a backbone network, the method comprising:
establishing a direct data pathway between the first end point device and a second end point device via the first access point and the backbone network;
exchanging data with the second end point device via the direct data pathway;
establishing an indirect command pathway between the first access point and the first end point device via the second access point and the backbone network; and
exchanging a command with the first access point via the indirect command pathway.

24. The method of claim 23, wherein the exchanging of the command comprising delivery of the command to the first access point via the indirect command pathway.

25. The method of claim 23, wherein the exchanging of the command comprising receiving of the command from the first access point via the indirect command pathway.

26. The method of claim 25, further comprising servicing the command received from the first access point via the indirect command pathway.

27. The method of claim 23, wherein the command relates to the direct data pathway.
